(19) United States
(12) Patent Application Publication
(10) Pub. No.: US 2010/0275789 A1
(43) Pub. Date: Nov. 4, 2010

(54) TOASTER WITH REMOVABLE AND ADJUSTABLE CONVEYORS

(75) Inventors: BRIAN HEE-EUN LEE, WEST CHICAGO, IL (US); TERRY TAE-IL CHUNG, BARTLETT, IL (US); DONALD VAN ERDEN, WILDWOOD, IL (US)

Correspondence Address: Docket Clerk, 1000 JORIE BOULEVARD SUITE 144, OAK BROOK, IL, 60523, US

(73) Assignee: PRINCE CASTLE, INC, CAROL STREAM, IL (US)

(21) Appl. No.: 12/433,660

(22) Filed: Apr. 30, 2009

(51) Int. Cl. A47J 37/08

(52) U.S. Cl. 99/386

(57) ABSTRACT

A dual-sided, conveyor toaster provides operator-adjustable conveyors that are also operator removable. The removable conveyor assemblies are chain driven and removably supported in the toaster by re-positionable mounting mechanisms embodied as either adjustable pins that engage fixed slots or adjustable slots that engage fixed pins. Fixed pins can be located on the conveyor and engage adjustable slots in the toaster; adjustable pins can be located on the toaster and engage fixed slots on the conveyor. The conveyor assemblies use non-marring plates to urge food products against the heated platen surfaces and to carry the food products across the platen.

### BACKGROUND

A conveyor toaster is a well-known cooking device that uses a vertical or near-vertical heated platen and a slowly rotating conveyor, which urges a food product against the platen while it simultaneously drags a food product downwardly and across the platen's hot surface. By virtue of its design, a conveyor toaster is able to process food products continuously as opposed to the toasters commonly used by consumers, which process food products in a batch mode.

Conveyor toasters are ill-suited for consumer use because of their size, manufacturing cost, power requirements and the time required to pre-heat the platen to operating temperature. They are preferred by restaurants and food services however that require high-volume through-put and consistent heating/toasting.

A well-known problem with prior art conveyor toasters is that heavy-gauge wire conveyors that urge a food product against the platen and which moves the food product across the platen tends to leave marks in soft food products like breads and bagels. Another problem with prior art conveyor toasters is that most of them are able to process food products of only a single thickness due to the fact that the spacing or separation distance between the actual conveyor and the heated platen is fixed. Food products that are too thin will thus fall through a prior art conveyor toaster. Food products that are too thick can jam the conveyor in place. Yet another problem with prior art conveyor toasters is that they are difficult to clean because the conveyors are fixedly attached to the toaster bodies. A conveyor toaster that was adjustable, which facilitated removal of the conveyor mechanisms and which did not leave marks on delicate food products that need to be heated or toasted would be an improvement over the prior art.

### BRIEF DESCRIPTION OF THE DRAWINGS

FIG. 1 is a perspective view of a conveyor toaster having removable and adjustable conveyors;

FIG. 2 is a perspective view of the toaster shown in FIG. 1 with the conveyor assemblies removed;

FIG. 2A is a perspective view of the toaster shown in FIG. 1 with a non-stick sheet over the toaster platen;

FIG. 3A and FIG. 3B show cut-away views of the toaster of FIG. 1, FIG. 2 and FIG. 2A looking toward the platen and just in front of the left end panel of the left side of the toaster;

FIG. 4A is a view inside the left end housing of the toaster looking toward the platen, without the toaster drive mechanism and showing a first separation distance between the platen and one of the conveyors;

FIG. 4B is the same view shown in FIG. 4A but with a second and wider separation distance between the platen and the one conveyor;

FIG. 5 is a view of the bottom portion of the left end housing showing the conveyor drive mechanism omitted from FIG. 4A and FIG. 4B;

FIG. 6 is a perspective view of one of the conveyor assemblies;

FIG. 7 is a perspective view of an alternate embodiment of the toaster shown in FIG. 1;

FIG. 8 is a perspective view of an alternate embodiment of a conveyor assembly; and

FIG. 9 is a perspective view of an alternate embodiment of a conveyor toaster.

### DETAILED DESCRIPTION

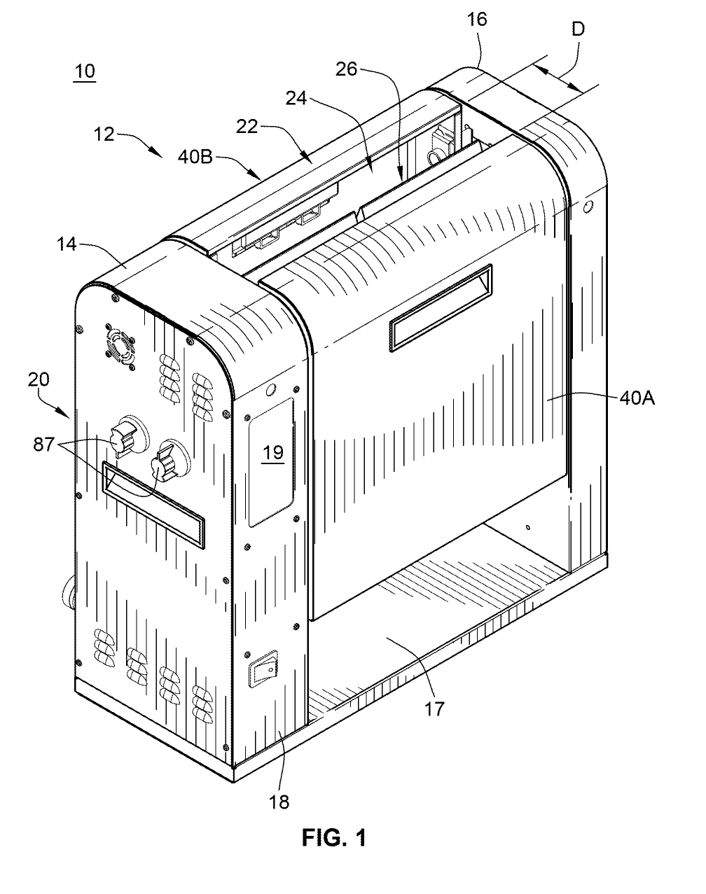

FIG. 1 is a perspective view of a conveyor toaster 10 (toaster) having removable and adjustable conveyors. The toaster 10 is comprised of a cabinet or housing 12 defined by a left end housing 14 and a right end housing 16, a front panel 18 with a liquid crystal display 19 and a rear panel 20. A top side 22 of the toaster 10 has an elongated rectangular food product opening 24 defined by the distance D separating two, removable conveyor assemblies 40A and 40B hung onto mounting pins, not shown in FIG. 1.

The conveyor assemblies 40A and 40B are described below and depicted in other figures. Food products to be heated or toasted using the toaster 10 are placed into the opening 24 where the food product can be “grabbed” by one of two, independently operated and independently-adjustable and independently-removable conveyor assemblies 40A and 40B (conveyors), both of which urge food products against a heated platen 26 and drag food products downwardly, across one of two corresponding heated sides of the electrically-heated platen 26, the surface temperature of which can be adjusted by changing the current delivered to one or more heating elements embedded into the platen 26. By adjusting the surface temperatures of the platen 26 and the rotation speed of the conveyors, the toaster 10 is able to heat or toast one or more food products on one side of the platen 26 while heating or toasting one or more other food products on the other side of the food platen. Food products are dragged downwardly across the platen and dropped into a food collection area 17 from which the food product is retrieved by an operator.

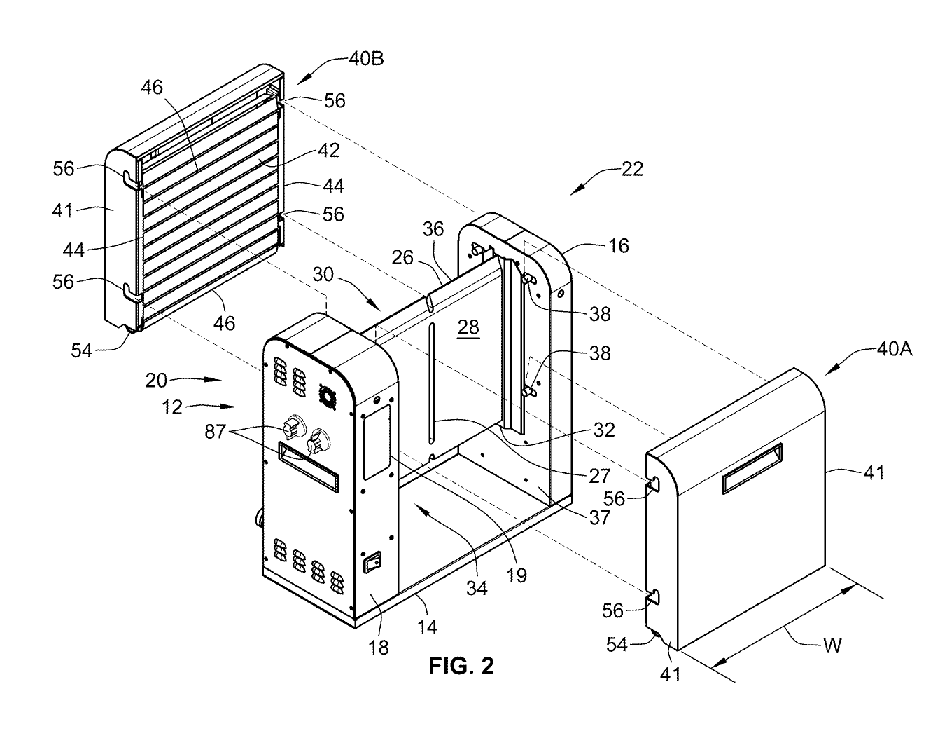

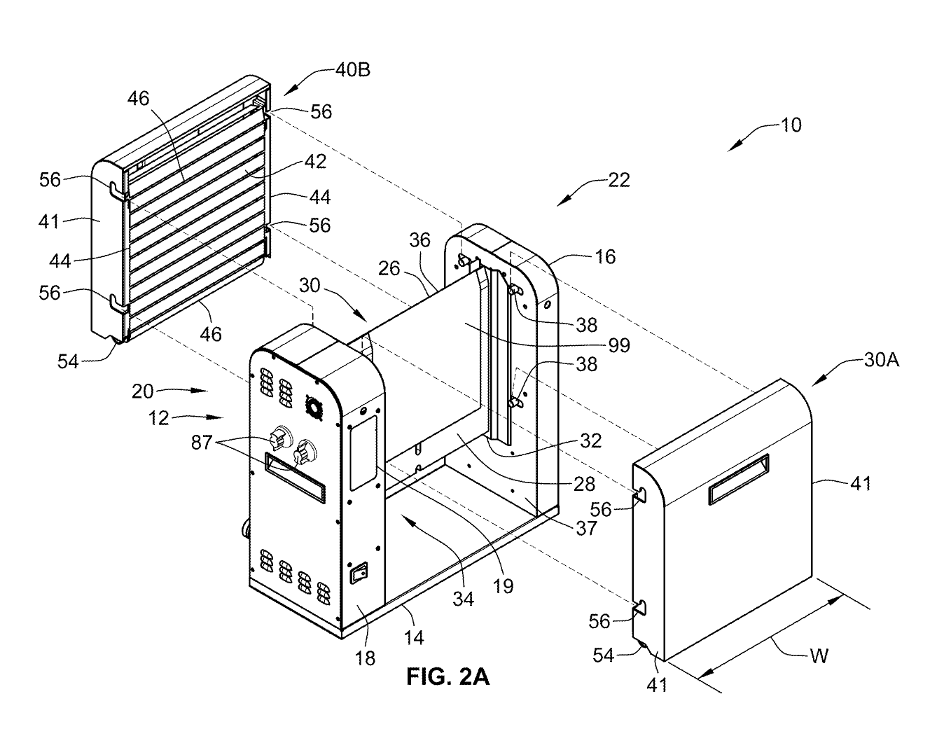

FIG. 2 is a perspective view of the toaster 10 with the conveyor assemblies 40A and 40B removed from mounting pins 38 they hang on and displaced from the toaster cabinet or housing 12 in order to provide a view of the interior of the toaster 10. Two operator-adjustable and movable mounting pins 38 project inwardly from the right end housing 16 as well as the left end housing 14 however, similar mounting pins 38 that extend from the left end housing 14 are not visible is FIG. 2 due to the angle at which the toaster 10 is viewed in this figure. Identical operator-adjustable and movable mounting pins on the opposite side of the platen 26 are not visible in the figure because they are obscured by the platen 26 and the left end housing 14.

In a preferred embodiment, the mounting pins 38 are approximately ½ inch diameter, stainless steel pins. They extend into the space between the left end housing 14 and the right end housing 16. The mounting pins 38 also extend through the end panels 37 attached to, and which form part of the left end housing 14 and right end housing 16 of the toaster 10. The conveyor assemblies 40A and 40B hang on the mounting pins. A mechanism described more fully below translates enables an operator to move or translate the mounting pins 38 toward and away from the platen 26 to allow an operator to selectably decrease and increase the separation distance between the platen surfaces and the conveyors.

The platen 26 includes a thermal break 27 embodied as an air gap 27. Separate embedded heating elements embedded in the platen on either side of the thermal break 27 allow the two sides of the platen to be heated separately. One lateral portion of the platen (left or right side of the thermal break 27) can be heated while the other, laterally adjacent portion is either heated or unheated. The platen 26 can also be embodied as any of the platens disclosed in the applicant's co-pending patent applications identified by U.S. application Ser. No. 12/267,449 filed Nov. 7, 2008, Ser. No. 12/329,358 filed Dec. 5, 2008, Ser. No. 12/329,373 filed Dec. 5, 2008, Ser. No. 12/329,397 filed Dec. 5, 2008, and Ser. No. 12/329,413, filed Dec. 5, 2008, the contents of each is incorporated herein by reference. Using one or more such platens disclosed in the aforementioned co-pending applications in the toasters disclosed herein, it is possible to heat a first side of a food product against a first side of a platen and laterally translate the food product as shown in the aforementioned co-pending applications such that the second side of the food product is heated against an opposite side of the same platen.

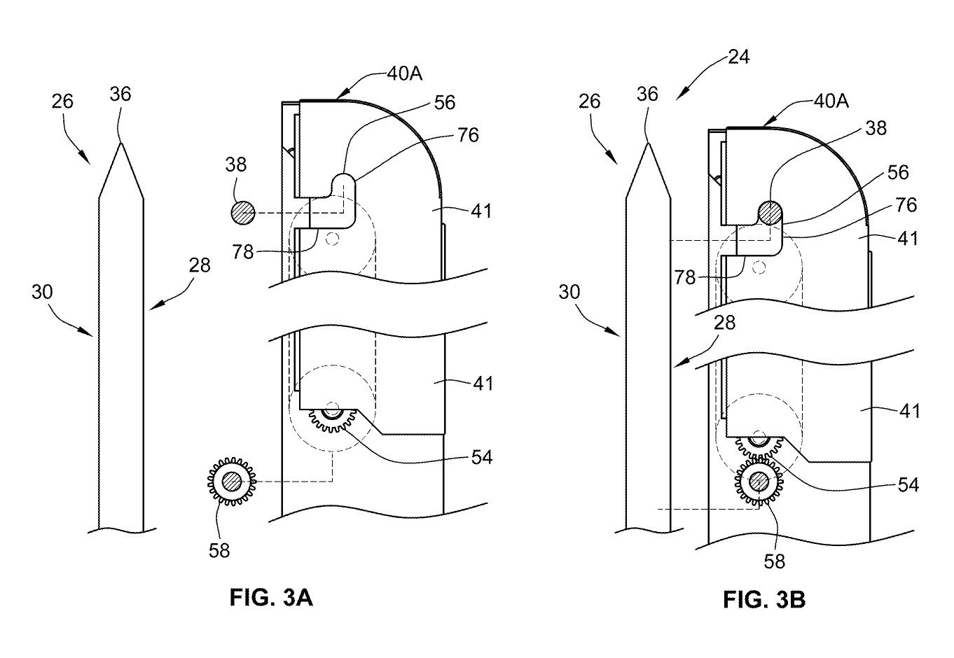

The conveyor assemblies 40A and 40B are identical in that both of them are separately adjustable during operation and separately removable from the toaster 10. As can be seen in FIG. 2, the conveyor assemblies 40A and 40B can be removed simply by lifting them upward a slight distance equal to the vertical height (See reference numeral 76 in FIGS. 3A and 3B.) of the saddles 56 to remove the conveyor assembly weight from the mounting pins 38. Once the conveyor assemblies 40A and 40B are lifted so that the mounting pins 38 are at the vertex of the L-shaped saddles 56, the conveyor assemblies 40A and 40B can be removed from the toaster by pulling them horizontally away from the platen 26 until the mounting pins 38 are clear of the mounting saddles 56 formed into the sides 41 of the conveyor assemblies 40A and 40B. No tools are required to remove the conveyor assemblies 40A and 40B, which facilitates the cleaning and maintenance of both the conveyor assemblies 40A and 40B as well as the platen 26. The platen 26 on the other hand is fixedly attached to the end panels 37 that form part of the left end housing 14 and the right end housing 16 of the toaster 10.

The platen 26 has a first side 28 that faces the front or first conveyor assembly 40A and an identical opposing side 30 (not visible in FIG. 2) facing the second conveyor assembly 40B. In a preferred embodiment, the platen is cast aluminum, the surface of which is smooth to allow food products to slide over it without requiring a non-stick coating that can deteriorate when platen surface temperatures exceed about four hundred degrees Fahrenheit. In order to facilitate toasting without tearing a bread product's surface, an alternate embodiment uses a platen having a non-stick coating applied to the platen surfaces 28 and 30 as well as the surfaces of the beveled top edge 36, which is beveled on each side 28 and 30 in order to facilitate food product insertion into the space between the heated surfaces of the platen 26 and the conveyors belts in each of the conveyor assemblies 40A and 40B. In yet another embodiment shown in FIG. 2A, a thin, flexible and replaceable non-stick sheet 99, such as a sheet of Teflon® draped over the beveled edge 36 of the platen 26 and which extends downward from the beveled edge 36 and over both of the side surfaces 28 and 30.

As stated above and as can be seen in figures described below, the mounting pins 38 are adjustable and configured and arranged to move horizontally, i.e., laterally toward and away from the platen 26 by the rotation of conveyor control shafts for each side of each platen and which extend out from both the left side housing 14 and the right side housing 16 but which are not visible in FIG. 1 or FIG. 2. The conveyor control shafts extend through the housing (14 and 16) and have operator operable control knobs 87 that are fastened to portions f the shafts that extend beyond and outside the housings 14 and 16. Stated another way, the lateral position or location of the mounting pins 38 that extend inwardly from the each housing 14 and 16 are separately and independently operator adjustable relative to the mounting pins 38 that extend from the opposite housing 16 and 14, simply by rotating the conveyor control knobs 87. The lateral and independent translation of mounting pins 38 at the left side housing 14 and the lateral and independent translation of mounting pins 38 on the right side housing 16 allows the conveyor assemblies 40A and 40B to be moved toward and away from the platen surfaces to accommodate thinner and thicker food/bread products in the toaster 10 independently of each other. When the mounting pins 38 that extend from the two end housings 14 and 16 are moved the same amount and in the same direction, the conveyor assemblies 40A and 40B are moved parallel relative to the platen 26 and maintained parallel or substantially parallel to the platen 26. Conversely, different movement of the mounting pins 38 from either the left side housing 14 or the right side housing 16 relative to the opposite side housing enables the conveyor assemblies to be made anti-parallel to the platen surfaces.

As described herein, the conveyor assemblies 40A and 40B are hung in the toaster 10 using L-shaped slots or saddles 56 that are cut, stamped, machined or otherwise formed into the sides 41 of the conveyor assemblies 40A and 40B to receive the movable mounting pins 38. The width W of the conveyor assemblies 40A and 40B and the distance between the two end panels 37 and pins 38 allow the conveyor assemblies 40A and 40B to move freely between the end panels 37. The length of the mounting pins 38 that extend toward each other is such that the conveyor assemblies 40A and 40B can be mounted onto them and therefore into the toaster 10 without requiring tools or fasteners. The conveyor assemblies 40 can be removed simply by lifting the conveyor assemblies off the pins without tools or special fasteners and pulling the conveyor assemblies away from the platen 26 and out of the toaster 10. When the conveyor assemblies 40A and 40B are dropped into position, a gear 54 in each conveyor assembly 40A and 40B engages a mating drive gear 58 located at the bottom and in front of the end panel 37 on the left side housing 14 but not seen in FIG. 2 due to the angle at which the toaster 10 is depicted in the figure. The conveyor assembly drive gear 58 in the toaster 10 is attached to and rotates on an axle that extends through the left end housing 14 of the toaster 10, the opposite end of which is fixed to a sprocket 56 driven by a chain 58 that extends around a variable speed drive motor 60 sprocket 62 located inside the left end housing 14.

FIGS. 3A and 3B show cut-away views of the toaster in that they show the view looking toward the platen 26 from just in front of the left end panel 37 of the left side housing 14. FIG. 3A shows the conveyor assembly 40A removed from the toaster 10 and disengaged from the mounting pins 38 and a conveyor drive gear 58 that rotates a conveyor (not shown) inside the conveyor assembly 40A. FIG. 3B shows the conveyor assembly 40B installed in the toaster 10 and with the conveyor drive gear 58 engaged to a mating conveyor driven gear 54.

FIG. 3A shows that as the conveyor assembly 40A is moved to the left of the figure, the mounting pins 38 enter a horizontal section 78 of the L-shaped saddles 56 formed into the sides 41 of the conveyor assemblies 40A and 40B. Stated another way, the horizontal section 78 of the L-shaped saddle 56 can freely slide over the mounting pin 38 as the conveyor assembly 40A is moved to the left in FIG. 3A as an operator would do when he or she is installing or replacing a conveyor assembly into the toaster 10.

As the conveyor assembly 40A is moved further to the left of the figure, the mounting pin 38 eventually reaches the vertex or intersection of the horizontal section 78 and vertical section 76 of the L-shaped saddle 56. When the conveyor assembly 40A is at its left-most position, i.e., the intersection of the horizontal section 78 and vertical section 76 of the L-shaped saddle 56, the conveyor assembly 40A is lowered onto the mounting pins 38 such that the conveyor assembly 40A rests on the mounting pin 38 located at the top of the vertical section 76 of the L-shaped saddle 56. When the conveyor assembly 40A is resting on the mounting pins 38, the conveyor assembly 40A is effectively locked into the toaster by its own weight. The conveyor assembly 40A can be subsequently removed by lifting it upward and off the mounting pins 38 and pulling it laterally or horizontally away from the platen 26.

FIG. 3B shows that when the conveyor assemblies are seated in place and resting on the mounting pins 38, the toaster drive gear 58 fully engages the conveyor drive gear 54. After the conveyor assembly 40A is seated and resting on the mounting pins 38 and after the gears are engaged, a drive mechanism inside the left side housing 14 allows the conveyor assemblies 40A and 40B to be individually adjusted to be moved toward and away from the platen 26, under operator control, even while the conveyors are rotating.

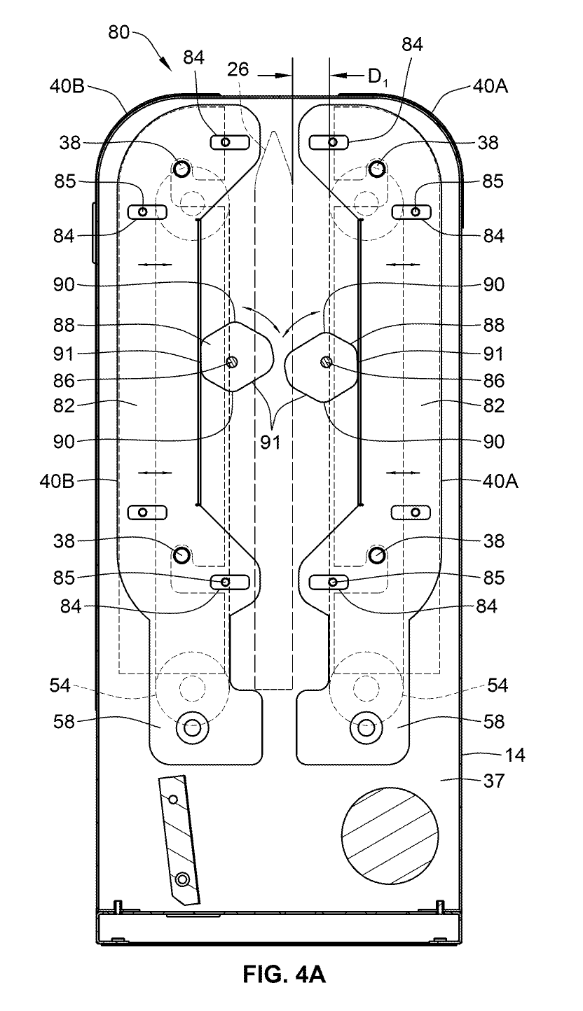

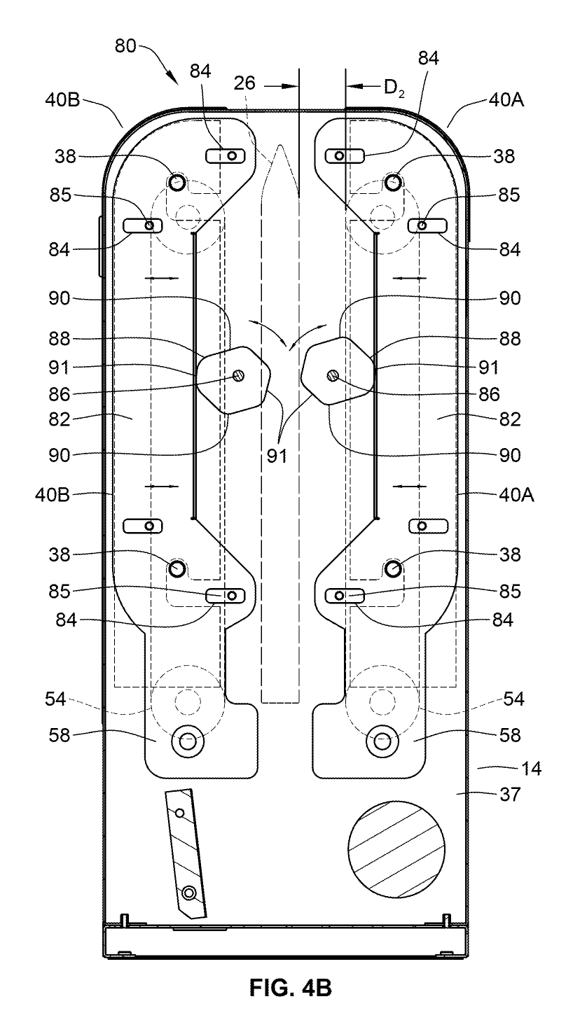

FIG. 4A is a view inside the left end housing 14 of the toaster 10, looking toward the platen 26 but without the aforementioned chain drive mechanism that drives conveyors inside the conveyor assemblies. FIG. 4A thus shows the two transmission mechanisms 80 that effectuate horizontal movement of the mounting pins 38 by the rotation of a conveyor location control shafts 86, which in FIG. 4A extends out of the plane of FIG. 4A and to which the control knobs 87 shown in FIGS. 1 and 2 are attached. As described more fully below, rotation of the control knobs 87 by an operator of the toaster 10 causes corresponding conveyor assemblies 40A and 40B to translate sideways, i.e., toward and/or away from the surfaces 28 and 30 of the platen 26.

As stated above, the conveyor location control shafts 86 (shafts) in FIG. 4 extend out of the plane of the figure and are therefore depicted as shaded circles. Although the conveyor location control shafts 86 extend out of the plane of the figure, as can be seen in FIG. 1 and FIG. 2, their distal ends (farthest out from the plane of FIG. 4A) have control knobs 87 attached to them that enable the shafts 86 to be rotated by an operator of the toaster 10. In an alternate embodiment not shown, the separation distance between the platen 26 and one or both of the conveyor assemblies 40A and 40B is set once when the toaster is manufactured or when the toaster is installed at an operator's premises and not operator changeable. In such an embodiment, the conveyor location control shafts 86 are short, they do not extend out of the left end housing 14 and the control knobs 87 shown in FIGS. 1 and 2 are omitted.

The ends of the shafts 86 located in the plane of FIG. 4A are attached to flat and substantially planar but irregularly-shaped cams 88. Each cam 88 is provided with several different lobes 90 having different heights, relative to a central axis of the shafts 86. The cam lobe heights define cam flats 91. Each cam flat 91 has a different height or perpendicular distance from the central axis of each shaft 86. As used herein, perpendicular distance from the central axis of a shaft 86 means the distance between the geometric center of the shaft 86 and cam flat 91 when measured along a line perpendicular to the surface of a cam flat 91 at the geometric midpoint of a cam flat 91. The perpendicular distance between a cam flat 91 and the central axis of the shafts 88 defines a horizontal displacement of a spring-biased mounting pin actuator plate 82 (actuator plate), the function of which is to keep two mounting pins 38 on one side of the toaster in the same vertical plane relative to the platen 26 as the actuator plate moves horizontally in response to rotation of a cam 90.

The mounting pins 38 described above and which extend through the end panels 37 also extend into the end housings 14 and 16 and through mounting pin holes 84 formed into the actuator plates 82 inside both the left and right end housings 14 and 16. Stated another way, the mounting pins 38 that extend inward from the left housings 14 and toward the right end housing 16 and which the conveyor assemblies hang on also extend into the left and right housings and through mounting pin holes 84 formed in the actuator plates 82 located in each housing 14 and 16 for each pair of mounting pins 38.

The actuator plates 82 have horizontal elongated slots 87, the surfaces of which ride on bearings 89 fixed into the end plates 37 and that allow the actuator plates 82 to freely translate left and right responsive to rotation of the cam 90. In the preferred embodiment, each actuator plate 82 is provided with four elongated horizontal slots 87 to keep the actuator plates 82 vertical and to prevent them from becoming “cocked” or jammed. Alternate embodiments include the use of fewer than four slots 84 as well as more than four.

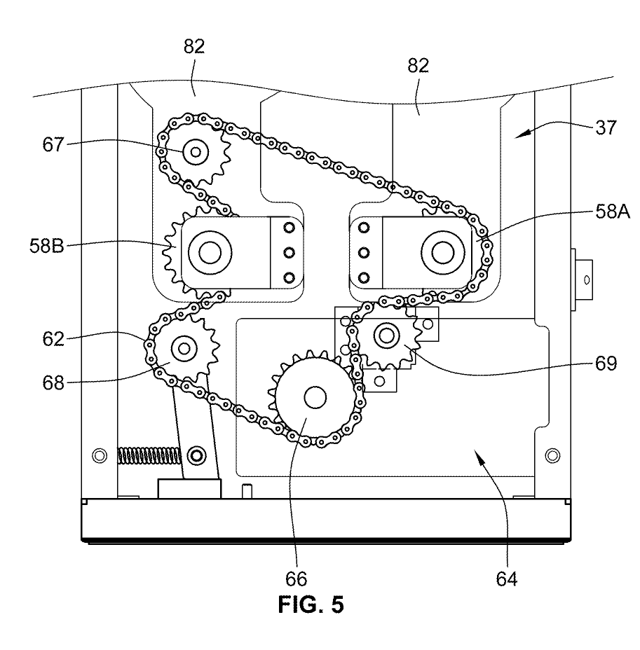

Rotation of the conveyor location control shafts 86 clockwise or counterclockwise rotates the cams 88 to various different positions where the lobes of the cams 90 cause the actuator plates 82 for each side of each conveyor assembly to move farther away from the platen 26 or closer to the platen 26. As the conveyor assemblies 40A and 40B are moved toward and away from the platen, tension in the drive chain 62 (not shown in FIG. 4A or 4B) is maintained by the aforementioned idler 68, best seen in FIG. 5. The toaster 10 is thus comprised of conveyors that are both removable, without requiring disassembly or tools and which are adjustable, even while the conveyors are operating.

It should be noted that in FIG. 4A, the front or first conveyor assembly 40A is depicted as being separated from the platen 26 by a distance identified as D₁. FIG. 4B on the other hand is identical to FIG. 4A except that the platen/conveyor separation distance is D₂, with D2 being depicted in FIG. 4B as being greater than D₁ in FIG. 4A.

FIG. 5 is a view of the bottom portion of the left end housing 14 shown in FIGS. 4A and 4B, with the drive chain and sprockets in place. A variable speed A.C. or D.C. drive motor 64 is geared to rotate a drive motor sprocket 66. In a preferred embodiment, the drive motor sprocket 60 rotation speed varied between about 5 RPM and 30 RPM. The conveyor speed is between about one and fifteen per minute, however, the conveyor speed range can be changed by changing the motor speed range and/or the gear ratio between the various sprockets.

The drive motor 64 (and drive motor sprocket 66) pulls a drive chain 62, that runs over a first routing sprocket 69, a first conveyor drive sprocket 58A for the right side conveyor assembly 40A, a second routing sprocket 67, a second conveyor drive sprocket 58B for the left or second side conveyor assembly 40B and a single spring-loaded chain idler sprocket 68. Two idler sprockets can also be used. The first conveyor drive sprocket 58A and the second conveyor drive sprocket 58B are both chain driven as the figures depicts, but they are fixedly attached to rotating drive shafts (not shown) that extend through the end panels 37 and into the space between the left end housing 14 and right end housing 16 where the conveyor assemblies 40A and 40B are hung on the aforementioned mounting pins 38. The aforementioned drive gears 58 (one shown in FIGS. 3A and 3B) engage mating conveyor drive gears 54 in the conveyor assemblies 40A and 40B. The chain 62, drive motor 64 and sprockets 58A and 58B are thus configured to rotate the conveyors in each conveyor assembly 40A and 40B, at the same speed.

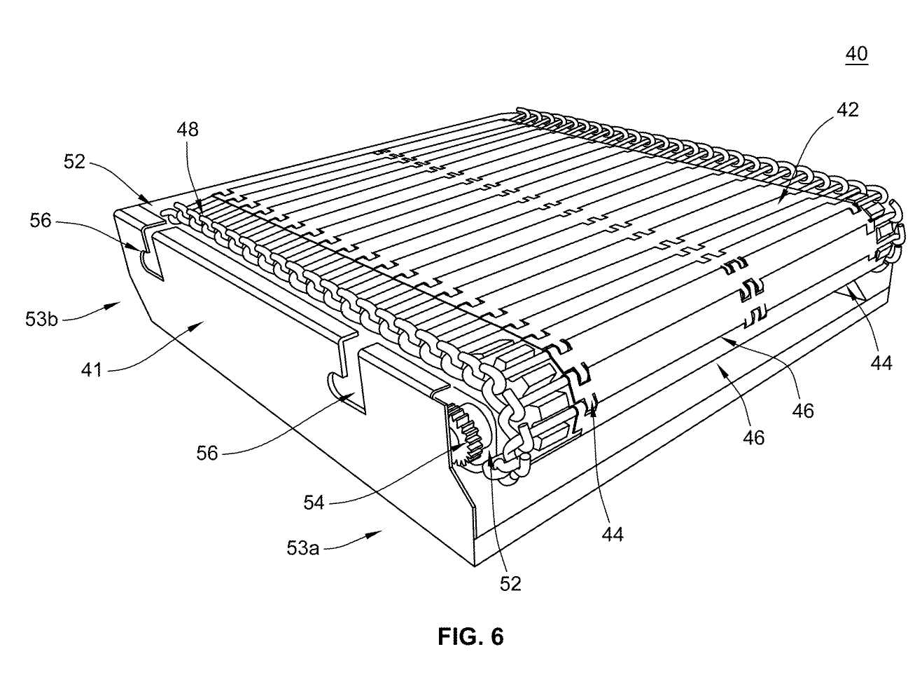

FIG. 6 is a perspective view of one of the conveyor assemblies 40A and 40B (conveyor assemblies) lying face up to reveal the structure and operation of the structure that urges food products against the platen 26 while simultaneously pulling them across the platen's heated surfaces. In a preferred embodiment, each conveyor assembly 40 is comprised of several thin, heat-absorbing, heat-conducting and heat-radiating rectangular metal plates 42. Each plate 42 has two ends 44 and two elongated edges 46 that abut the elongated edges 46 of an adjacent plate 42. The ends 44 of each plate are clipped to a conveyor chain 48 constructed of heavy wire links that wrap around a sprocket 52 at each end 53A and 53B of the conveyor assembly 40A and 40B. Unlike the prior art conveyors that use wire or wire mesh, the plates 42 used in the conveyor assemblies do not mar or leave imprints in food products. The plates 42 are therefore considered to be substantially non-marring in that their planarity tends to evenly distribute force applies to a food product by the conveyor assembly separation distance from the platen, however, reducing the separation distance too much will tend to flatten food products.

The sprocket 52 at a lower end 53A is attached to one end of a drive shaft (not shown) the opposite end of which is attached to the aforementioned drive gear 54 visible in the foreground of FIG. 6. The drive gear 54, which is at the lower end 53A of the conveyor assembly 40, mates with and engages the toaster's drive gear 58 (best seen in FIG. 2 and FIG. 3) when the conveyor assembly 40 is placed between the left and right ends 14 and 16 respectively, and resting on the mounting pins 38.

FIG. 6 also shows the aforementioned L-shaped saddles 56 formed into the sides 41 of the conveyor assemblies 40A and 40B and which are sized, shaped and arranged to receive the mounting pins 38. When the conveyor assembly 40 rests on the mounting pins 38, the drive gear 58 on the bottom end 53A of the conveyor assembly 40A engages the drive gear 54 on the toaster.

Once the conveyor assembly is in place and resting on the mounting pins 38, horizontal translation of the mounting pins 38 relative to the platen 26 as described above determines the spacing or separation distance between the conveyor assembly 40 and the metal plates 42 that it comprised of. Lateral movement or translation of the pins 38 thus enables the separation distance between the conveyor 40 and the platen 26 to be adjusted even while the conveyor is in the housing and operating. Lateral movement of the mounting pins 38 can therefore affect the pressure exerted against the platen 26 by a food product on the conveyor and therefore determine the upward force exerted by the toaster drive motor on the conveyor assemblies.

Those of ordinary skill in the art will recognize that the mounting slots or saddles 56 enable the mounting assembly to be hung or rested on the mounting pins 38 and that the conveyor assemblies 40A and 40B will be weighted downwardly by their own mass. Those of ordinary skill in the art will also recognize that when the metal plates 42 attached to the wire links of the conveyor assemblies are urging a food product downwardly across the platen 26 that an equal an opposite upward force will be exerted on the conveyor assemblies 40A and 40B through the plates 42 and wire links. The upward force attributable to moving a food product downwardly across the platen should be kept below the weight of the conveyor assembly 40A and 40B in order to avoid having the conveyor assembly 40A and 40B lift itself off the mounting pins 38.

With regard to the conveyor assemblies 40A and 40B, it is important to note that the plates 42 are embodied as heat-absorbing and heat-conducting as well as heat-radiating material. Heat energy radiated from the platen 26 as infrared is absorbed by the plates 42, which causes their temperature to rise. Hot air between the platen 26 and the plates 42 also causes their temperature to rise. Since the metal plates 42 absorb heat through both radiation and conduction, they will transfer at least some of that heat energy into a food product or bread product that contacts the surfaces of the plates 42. The thin heat-absorbing, heat-conducting and heat-radiating plates thus act to absorb heat energy from the platen and transfer at least some of that energy into a food product that contacts the surfaces of the metal plates 42. Heat transmission from the metal plates 42 to a food product occurs primarily by conduction, however, heat in the plates 42 can also be transferred into the food products on the conveyor by convection as well as radiation. Heat that the plates 42 absorb from the platen that is conveyed to the food products is considered herein to be “imparted” to the food products whether the heat transfer mechanism is by radiation, conduction or convection..

In addition to imparting heat to the food products on the conveyor, the plates 42 also act to thermally insulate the exterior surfaces of the toaster 10 that face the platen 26 from becoming excessively hot. More particularly, the metal plates 42 intercept infrared energy emitted from the platen 26 and thus effectively insulate exterior surfaces of the toaster 10 from the heat-emitting platen 26 and help to keep exterior surfaces of the toaster cooler than they would be otherwise.

The description above is with respect to a single conveyor for brevity and clarity. The preferred embodiment of the toaster 10 however is a dual-conveyor assembly toaster. Both conveyor assemblies 40A and 40B depicted in FIG. 2 are configured as described above and operate the same way. Both conveyor assemblies are capable of translating horizontally independently of each other; moreover, the left and right sides 41 of each conveyor assembly 40 are separately adjustable. Both conveyor assemblies are removable from the toaster, independently of each other. By moving the mounting pins 38 on one side of the conveyor toward or away from the platen, it is possible to position one or both of the platens to be anti-parallel to the platen surfaces. On the other hand, one side 41 of a conveyor assembly can be moved outwardly with respect to the platen while the other side 41 can be moved inwardly by rotation of the corresponding conveyor location control rods 86 making a conveyor assembly anti-parallel to the platen surfaces.

In a preferred embodiment, the metal plates 42 that comprise the conveyors 40A and 40B are provided with a predetermined surface roughness to facilitate the frictional engagement of a food product urged against the platen 26 after it is dropped into the space between the plates 42 and the platen 26. The roughness of the surface of the plates 42 is in one embodiment provided by shot peening the surfaces of the metal plates using a predetermined shot size. By selecting different shot sizes, the surface roughness can be changed to make the surface of the plates more or less irregular, increasing and decreasing the friction provided by the surface of the plates 42. In another embodiment surface roughness is provided by cold forming processes. In yet another embodiment, surface roughness is provided by abrading the plate surfaces with an appropriate abrasive medium.

As used herein, the term surface roughness is considered to be the arithmetic average deviation from the center line of the surface or as a RMS which is the route mean square of the deviations of the surface from the center line. Conveyor plate 42 surface roughness between 5 and 100 micrometers imbue the plates 42 with the ability to grab relatively smooth bread products and pull them across the hot surface of the platen 26 to prevent the food product from being stuck in place against the heated platen surface and burning without abrading the bread products' surfaces. In another embodiment, the plates 42 are provided with a surface “roughness” to frictionally engage a food product by a horizontal grain orientation.

As set forth above, the conveyor assemblies 40 are held in place and the gears engaged to each other solely by the weight of the conveyor assemblies themselves. Alternate embodiments include the use of one or more hold down springs and/or common barrel-bolt latches (not shown in the figures) to prevent the conveyor assemblies from being accidentally lifted out of position. Hold-down springs and/or barrel bolt latches will also reduce the likelihood that a conveyor assembly 40A or 40B might lift itself up and off the mounting pins 38 due to the reactive force created by the friction of a food product against the platen 26.

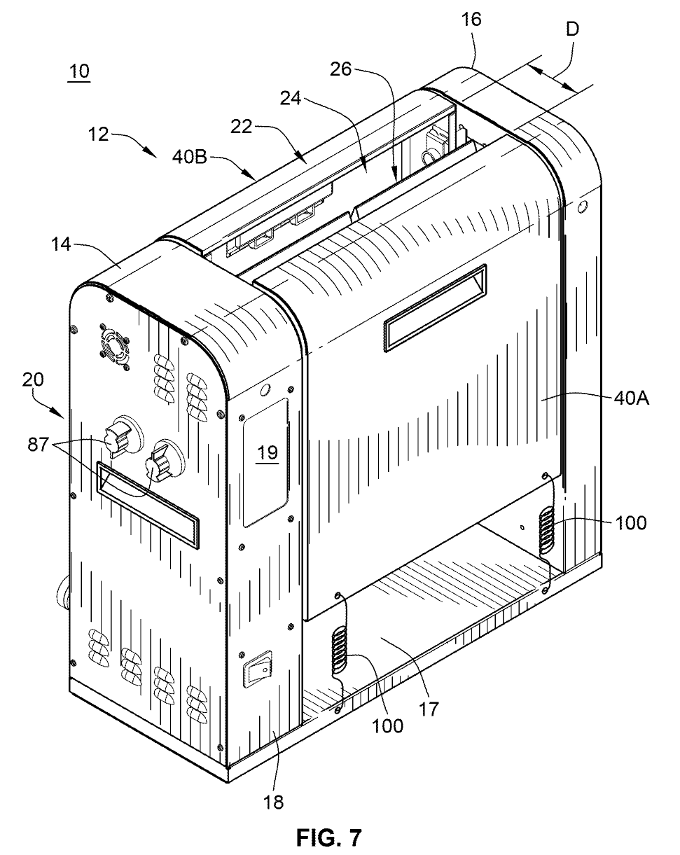

FIG. 7 shows an alternate embodiment of the toaster 10. A hold-down spring 100 embodied as a small, coiled spring attached to the bottom of the food collection area 17 adjacent a end panel 37 and stretched upwards is hooked to the bottom 53A of the conveyor assemblies 40A and 40B. The hold-down spring 100 biases the conveyor assemblies 40A and 40B downward and toward the mounting pins 38.

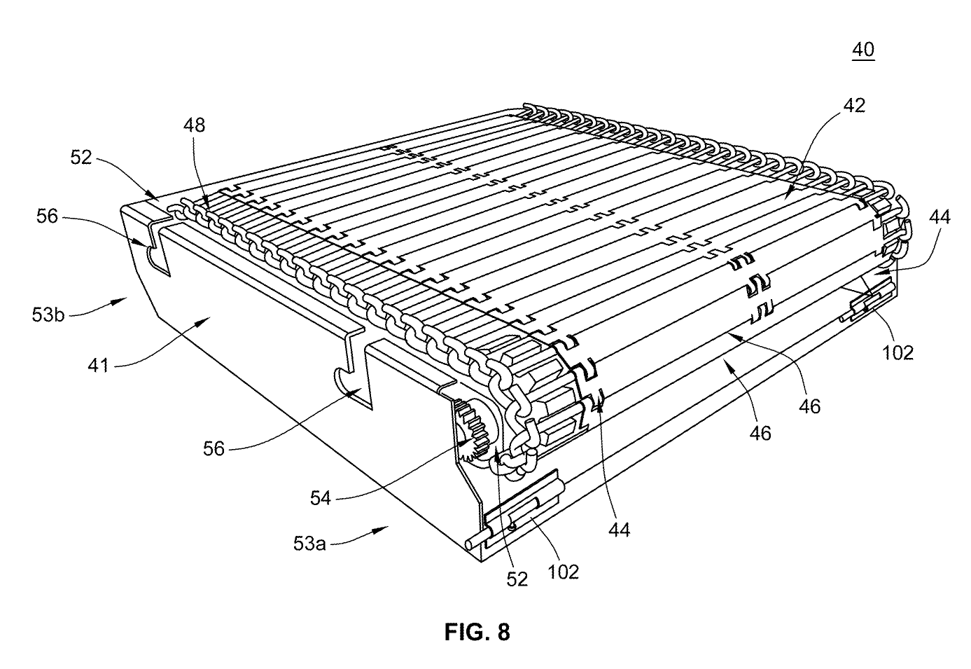

FIG. 8 shows an alternate embodiment of the conveyor assembly 40 shown in FIG. 6. A barrel bolt 102 is attached to the bottom edge 53A of the conveyor assemblies 40A and 40B proximate to the conveyor assembly sides 41. The barrel bolt 102 slide can be extended into a mating hole formed into the panel 37 (not shown) that receives the bolt. Once the barrel bold is extended into a hole in the panel 37, the conveyor assemblies 40A and 40B will be held in place and prevented from being lifted off the mounting pins 38.

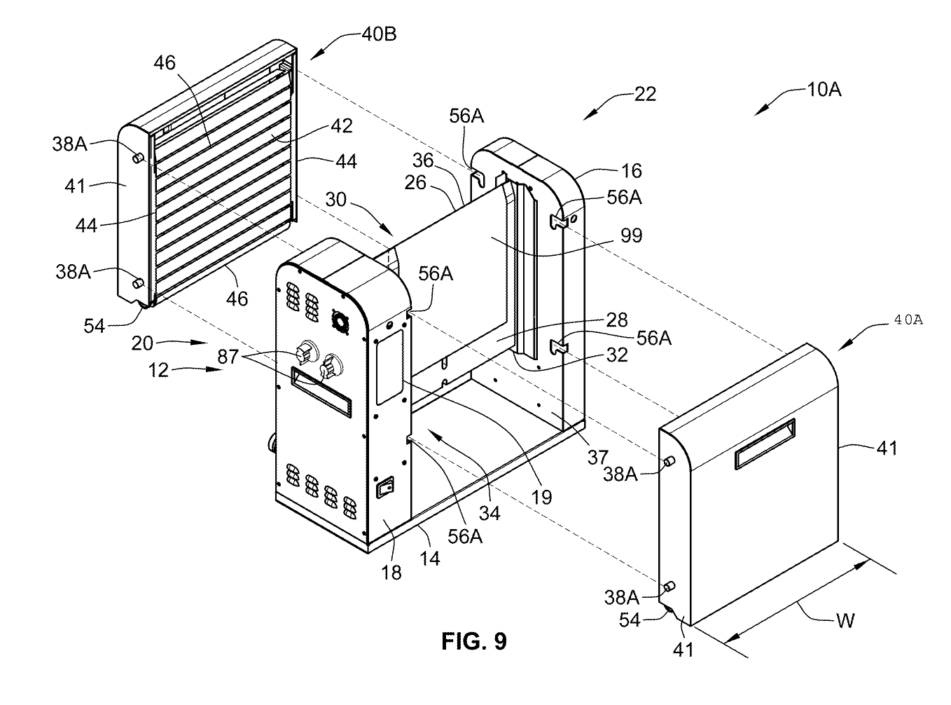

Finally, FIG. 9 shows an alternate embodiment of a conveyor toaster 10A. In FIG. 9, the mounting pins 38A are located on the conveyor assemblies 40A and 40B. L-shaped slots or saddles 56A are formed into the end panels 37A of the toaster 10A and into mounting pin actuator plates (not shown) to allow the mounting pins 38A to be slid inwardly, i.e., toward the platen 26 and lowered into the bottom of the vertical section of the L-shaped slot 56A. When the conveyor assemblies 40A and 40B with the protruding pins 38A are supported in the toaster 10A by the L-shaped slots 56A, rotation of the conveyor location control shafts (not shown) as described above causes L-shaped slots formed into the mounting pin actuator plates to move the mounting pins 38A toward and away from the platen. Lateral translation of the slots 56A thus translates the pins 38A and the conveyor assemblies 40A and 40B the pins 38A are attached to.

In either embodiment of the toaster (10 or 10A), mounting pins and the slots that the pins rest in are considered to be a “mounting mechanism.” The pin and slots support the conveyor assemblies in such a way that the conveyor assemblies can be lifted in and out of the toaster without tools and the lateral spacing of the conveyor assemblies from the platen 26 can be adjusted by an operator, even while the conveyors inside the conveyor assemblies 40A and 40B rotates. In the preferred embodiment of the toaster 10 where the pins 38 are located at the toaster 10, the pins 38 are movable and the slots 56 are “fixed” in that they are formed into the sides 41 of the conveyor assemblies 40A and 40B. In a second embodiment of the toaster 10A where the slots 56A are in the toaster 10A, the pins 56A are “fixed” in that they extend from the sides 41 of the conveyor assemblies 40A and 40B. The mounting pins and slots are thus considered herein to be a re-positionable mounting mechanism, whether pins are on the toaster or on the conveyor assemblies and whether slots are on the conveyor assemblies or on the toaster. It should be noted too that one of the two conveyor assemblies 40A or 40B can be configured to have slots formed in one or both of the sides 41 and be supported in the toaster housing by adjustable pins that extend from opposing end panels 37 while the other conveyor assembly 40B or 40A can be configured to have mounting pins extend from one or both of its sides 41 and be supported in the toaster housing by corresponding adjustable slots formed into opposing ends.

While the pins shown in the figures are cylindrical and having circular cross sections, the mounting pins can have other shapes. A mounting pin can have cross sections that are square, triangular, elliptical or rectangular, all of which are considered herein to be equivalent to the round cross-sectioned pins shown in the figures. The height or length of the mounting pins is a design choice and will be determined somewhat by the desired spacing between the end panels 37 and the conveyor assemblies sides 41.

Those of ordinary skill in the art will appreciate that in either embodiment, the conveyor assemblies 40A and 40B can be individually removed from the toaster 10 simply by lifting them vertically upward and pulling them away from the platens without requiring any tools or disassembly. Once the conveyor assemblies are removed from the toaster, they can be immersed in cleaning solutions because there are no heating elements or electrical connections in the conveyor assemblies.

The foregoing description is for purposes of explanation and illustration only. The true scope of the invention is defined by the appurtenant claims.

What is claimed is:

1. A food heating device comprised of:
a housing having first and second opposing ends;
a heated platen having first and second opposing heated sides between first and second opposing platen edges, the platen edges being attached to the housing at the first and second opposing ends;
a first conveyor facing the first heated side of the heated platen and removably supported in the housing by a re-positionable mounting mechanism, the first conveyor being separated from the first side of the platen by a first separation distance when the first conveyor is supported in the housing by said re-positionable mounting mechanism, the re-positionable mounting mechanism being configured such that the first separation distance is operator adjustable.

2. The food heating device of claim 1, wherein the re-positionable mounting mechanism is comprised of at least one adjustable mounting pin extending from the first end and a second adjustable mounting pin extending from the second end, said adjustable mounting pins being horizontally adjustable and wherein said first conveyor rests on said first and second adjustable mounting pins when said first conveyor is between said first and second opposing ends.

3. The food heating device of claim 1, wherein the re-positionable mounting mechanism is comprised of a first pair of adjustable mounting pins extending from the first end and a second pair of adjustable mounting pins extending from the second end and wherein said first conveyor rests on the mounting pins of said first and second pair of mounting pins when said second conveyor is mounted in said housing between the first and second opposing ends.

4. The food heating device of claim 2 or 3, wherein at least one of the first and second adjustable mounting pins is configured to move laterally toward and away from the platen, responsive to rotation of a conveyor location control shaft operatively coupled to said at least one of said first and second adjustable mounting pins.

5. The food heating device of claim 3, wherein the first pair of adjustable mounting pins is configured to move laterally toward the platen responsive to rotation of a first conveyor location control shaft operatively coupled to said first pair of adjustable mounting pins, and wherein the second pair of adjustable mounting pins is configured to move laterally toward the platen responsive to rotation of a second conveyor location control shaft operatively coupled to said second pair of adjustable mounting pins.

6. The food heating device of claims 4 or 5, wherein the lateral positions of the mounting pins relative to the platen are separately adjustable.

7. The food heating device of claim 6, wherein the first and second pairs of adjustable mounting pins are adjustable independently of each other by rotation of the first and second control shafts respectively.

8. The food heating device of claims 1, 2 or 3, wherein the first conveyor is comprised of a plurality of thin, non-marring plates, each plate having first and second ends and first and second elongated edges, the first and second ends being attached to a conveyor chain comprised of a plurality of wire links.

9. The food heating device of claim 8, wherein the conveyor chain is driven by a first gear and wherein the housing is provided with a second gear, the first and second gears being meshed when said conveyor rests on said adjustable mounting pins.

10. The food heating device of claim 8 or 9, wherein the non-marring plates have an average surface roughness to frictionally engage food products.

11. The food heating device of claims 1, 2, 3, 4, 5, 6, 7, 8, 9 or 10, further comprised of a variable speed drive motor and wherein the first conveyor is driven by a chain.

12. The food heating device of claim 11, wherein said chain is under tension and said tension is maintained by an idler.

13. The food heating device of claims 1, 2, 3, 4, 5, 6, 7, 8, 9, 10, 11 or 12 wherein the heated platen is configured to provide different surface temperatures at different areas of the platen.

14. The food heating device of claims 1, 2, 3, 4, 5, 6, 7, 8, 9, 10, 11, 12 or 13 wherein the food heating device is a toaster.

15. The food heating device of claims 1, 2, 3, 4, 5, 6, 7, 8, 9, 10, 11, 12, 13 or 14 wherein the platen and the conveyor are substantially parallel to each other.

16. The food heating device of claim 8, wherein the metal plates are configured to insulate exterior surfaces of the toaster from infrared energy emitted by said platen.

17. The food heating device of claim 8, wherein the metal plates are configured to absorb heat emitted from the platen and to impart at least some of the absorbed heat into a food product.

18. The food heating device of claims 2, 3 or 4, further comprised of a Teflon® sheet draped over the platen.

19. The food heating device of claim 1, further comprised of a hold-down spring, configured to bias the conveyor assembly downward.

20. The food heating device of claims 2, 3, 4 or 19 further comprised of a barrel bolt configured to latch the conveyor assemblies to the housing.

21. The food heating device of claims 2, 3, 4 further comprised of a means for preventing the conveyor assemblies from being removed from the housing.

22. The food heating device of claim 1, wherein the re-positionable mounting mechanism is comprised of a first mounting pin extending from a first side of the first conveyor and a second mounting pin extending from a second side of the first conveyor, said first and second mounting pins resting in corresponding adjustable slots on the housing.

23. The food heating device of claim 1, wherein the re-positionable mounting mechanism is comprised of a first pair of mounting pins extending from a first side of the first conveyor and a second pair of mounting pins extending from a second side of the first conveyor, the first and second pairs of mounting pins resting in corresponding first and second pairs of adjustable slots on the housing.

24. The food heating device of claim 22, wherein adjustable slots are configured to move laterally toward and away from the platen, responsive to rotation of a conveyor location control shaft operatively coupled to said at least one of said first and second adjustable slots.

25. The food heating device of claim 23, wherein the first pair of adjustable slots is configured to move laterally toward the platen responsive to rotation of a first conveyor location control shaft operatively coupled to said first pair of adjustable mounting pins, and wherein the second pair of adjustable slots is configured to move laterally toward the platen responsive to rotation of a second conveyor location control shaft operatively coupled to said second pair of adjustable slots.

26. The food heating device of claims 22 or 23, wherein the lateral positions of adjustable slots are separately adjustable.

27. The food heating device of claim 23, wherein the first and second pairs of adjustable slots are adjustable independently of each other by rotation of first and second control shafts.

28. A food heating device comprised of:
a housing having first and second ends;
a heated platen having first and second heated sides between first and second platen edges, the platen being attached to the housing proximate the first and second ends;
a first conveyor assembly facing the first side of the heated platen and removably supported in the housing by a first re-positionable mounting mechanism, the first conveyor assembly being separated from the first heated side by a first adjustable distance; and
a second conveyor assembly facing the second side of the heated platen, the second conveyor being removably supported in the housing by a second re-positionable mounting mechanism, the second conveyor assembly being separated from the second heated side by a second adjustable distance;
whereby the first and second re-positionable mounting mechanism are configured such that the first and second adjustable distances can be changed by an operator while the first and second conveyors are in the housing.

29. The food heating device of claim 28, wherein the first and second conveyor assemblies are configured such that the first and second adjustable distances are separately adjustable, and independently of each other.

30. The food heating device of claim 28, wherein the first conveyor assembly is substantially parallel to the first side of the platen and wherein the second conveyor assembly is substantially parallel to the second side of the platen.

31. The food heating device of claim 28, wherein at least one of the first and second conveyor assemblies is configured to be adjustable to be anti-parallel to the corresponding first and second sides of the platen.

32. The food heating device of claim 28, wherein the first and second conveyor assemblies are removably mounted in the housing by first and second opposing pairs of adjustable mounting pins extending from the first and second ends respectively, there being first and second opposing pairs of adjustable mounting pins extending from the first and second ends, on each side of the platen.

33. The food heating device of claim 32, wherein each pair of adjustable mounting pins is laterally movable toward and away from the platen, responsive to rotation and anti-rotation of a corresponding conveyor location control shaft coupled to a corresponding pair of adjustable mounting pins.

34. The food heating device of claims 28, 29, 30, 31, 32 and 33, wherein at least one of the first conveyor assembly and the second conveyor assembly are comprised of a plurality of thin, rectangular substantially non-marring plates, each plate having first and second ends and first and second elongated edges, the first and second ends being attached to and moving with a conveyor chain.

35. The food heating device of claim 34, wherein the conveyor chain of both the first conveyor and the second conveyor is connected to a drive gear and wherein the housing is provided with a second gear in front of the first side of the platen and a third gear in front of the second side of the platen, the first conveyor drive gear and the second gear being meshed when said first conveyor rests on said first and second pairs of pins, the second conveyor drive gear and the third gear being meshed when the second conveyor rests on the third and fourth pair of pins.

36. The food heating device of claim 34 or 35, wherein the rectangular metal plates have an average surface roughness to frictionally engage a food product.

37. The food heating device of claim 28, 29, 30, 31, 32, 33, 34 or 35, further comprised of a variable speed drive motor and wherein the first conveyor and the second conveyor are both driven by a single chain.

38. The food heating device of claim 37, wherein said chain has a predetermined tension and said tension is maintained by a single idler.

39. The food heating device of claims 28, 29, 30, 31, 32, 33, 34 or 35, wherein the heated platen is configured to provide adjustable surface temperatures of the first and second ends.

40. The food heating device of claim 39, wherein the food heating device is a toaster.

41. The food heating device of claim 34, wherein the metal plates are configured to insulate exterior surfaces of the toaster from infrared energy emitted by said platen.

42. The food heating device of claim 34, wherein the metal plates are configured to absorb heat emitted from the platen and to impart at least some of the absorbed heat into a food product.

43. The food heating device of claims 28, further comprised of a Teflon® sheet over the platen.

44. The food heating device of claim 28, further comprised of a hold-down spring, configured to bias at least one of the conveyor assemblies downward.

45. The food heating device of claims 28, further comprised of a barrel bolt configured to latch at least one of the conveyor assemblies to the housing.

46. The food heating device of claims 28, further comprised of a means for preventing the conveyor assemblies from being removed from the housing.

47. The food heating device of claim 28, wherein the first and second conveyors and the platen are configured to heat a first side of a first food product against a first side of the platen and to heat the second side of the first food product against the second side of the platen.
